(19) United States
(12) Patent Application Publication
(10) Pub. No.: US 2023/0271428 A1
(43) Pub. Date: Aug. 31, 2023

(54) RECORDING APPARATUS AND MEDIUM PROCESSING APPARATUS

(71) Applicant: SEIKO EPSON CORPORATION, Tokyo (JP)

(72) Inventors: Hisayuki AKAHANE, MATSUMOTO-SHI (JP); Seiji MIYAZAWA, MATSUMOTO-SHI (JP)

(21) Appl. No.: 18/313,649

(22) Filed: May 8, 2023

Related U.S. Application Data
(63) Continuation of application No. 16/377,715, filed on Apr. 8, 2019.

(30) Foreign Application Priority Data
Apr. 9, 2018 (JP) 2018-074543

(51) Int. Cl. B41J 3/46; B41J 29/42; F21V 8/00; B41J 29/13

(52) U.S. Cl. CPC B41J 3/46; B41J 29/42; G02B 6/0001; B41J 29/13; B41J 29/02

(57) ABSTRACT

In a printer, a display unit includes, in a housing, a light source, and a first light emitting portion having a first light emitting surface which emits light toward the outside of the housing with light emitted from the light source and a first light guiding portion which guides the light emitted from the light source to the first light emitting surface. Further, the display unit includes, in an opening/closing cover, a second light emitting portion having a second light emitting surface which emits light toward the outside of the housing with the light emitted from the first light emitting surface and a second light guiding portion which guides the light emitted from the first light emitting surface to the second light emitting surface.

The present application is a continuation of U.S. patent application Ser. No. 16/377,715, filed Apr. 8, 2019, which is based on, and claims priority from, JP Application Serial Number 2018-074543, filed Apr. 9, 2018, the disclosures of which are hereby incorporated by reference herein in their entirety.

### BACKGROUND

### 1. Technical Field

The present disclosure relates to a recording apparatus performing recording on a medium and a medium processing apparatus performing predetermined processing on the medium.

### 2. Related Art

Among medium processing apparatuses that perform predetermined processing on a medium, for example, a recording apparatus represented by an ink jet printer and an image reading apparatus represented by a scanner, there is an apparatus including a display unit that displays a state of the apparatus, such as a standby state or an error state, by lighting or flashing of a lamp, a lamp color, or the like.

JP-A-6-106817 discloses a display unit (an indicator 17 in JP-A-6-106817) configured to enable light to be visually recognized from the outside of an apparatus by providing a light emitting source in the apparatus and guiding light emitted from the light emitting source to a window provided on an exterior cover by a light guiding member.

The above-described display unit needs to be provided at such a position that it is visually recognized easily from the outside of the apparatus and therefore has restriction in a layout in some cases.

For example, when the recording apparatus includes a contact/separation member that can switch a state of making contact with an apparatus exterior and a state of being separated from the apparatus exterior, like an opening/closing cover for opening and closing a part of the apparatus exterior, a layout enabling the display unit to be visually recognized in both of the state in which the contact/separation member makes contact with the apparatus exterior (a closed state in the case of the opening/closing cover) and the state in which the contact/separation member is separated from the apparatus exterior (an open state in the case of the opening/closing cover) is required in some cases.

### SUMMARY

An advantage of some aspects of the present disclosure is to arrange a display unit displaying a state of an apparatus by light in consideration of both of visibility and the degree of freedom of a layout.

A recording apparatus according to a first aspect of the present disclosure includes a recording unit performing recording on a medium, a housing that houses the recording unit, a displacement member displaceable relative to the housing and configured to be switchable between a first state and a second state of being separated further from the housing than the first state, and a display unit displaying a state of the apparatus using light, wherein the display unit includes a light source, and a first light emitting portion in the housing, the first light emitting portion having a first light emitting surface which emits light toward outside of the housing with light emitted from the light source and a first light guiding portion which guides the light emitted from the light source to the first light emitting surface, and the display unit further includes a second light emitting portion in the displacement member, the second light emitting portion having a second light emitting surface which emits light toward the outside of the housing with the light emitted from the first light emitting surface and a second light guiding portion which guides the light emitted from the first light emitting surface to the second light emitting surface when the displacement member is in the first state.

With this aspect, the display unit includes the light source, and the first light emitting portion in the housing, the first light emitting portion having the first light emitting surface which emits light toward the outside of the housing with the light emitted from the light source and the first light guiding portion which guides the light emitted from the light source to the first light emitting surface, and includes, in the displacement member, the second light emitting portion having the second light emitting surface which emits light toward the outside of the housing with the light emitted from the first light emitting surface and the second light guiding portion which guides the light emitted from the first light emitting surface to the second light emitting surface when the displacement member is in the first state. Therefore, the display unit can be visually recognized in both of the first state and the second state of the displacement member. Furthermore, one light source enables both of the first light emitting portion and the second light emitting portion to emit light and the degree of freedom of a layout of the display unit can be enhanced.

In a second aspect of the present disclosure, the displacement member may be an opening/closing cover configured to be switchable between, by pivoting, a closed state, as the first state, of making contact with the housing and an open state, as the second state, of being separated from the housing, in the first aspect.

With this aspect, the same action effects as those obtained by the first aspect can be obtained in the recording apparatus including the opening/closing cover, as the displacement member, configured to be switchable between the closed state of making contact with the housing to make an apparatus inner portion be inaccessible and the open state of being separated from the housing to make the apparatus inner portion be accessible.

In a third aspect of the present disclosure, the first light emitting surface may be arranged so as not to be visually recognized when the displacement member is made into the first state, in the first aspect or the second aspect.

With this aspect, the first light emitting surface is arranged so as not to be visually recognized when the displacement member is made into the first state. Therefore, the light can be preferably guided to the second light emitting surface while suppressing leakage, to the outside, of the light emitted from the first light emitting surface and attenuation of the light when the displacement member is in the first state.

In a fourth aspect of the present disclosure, the opening/closing cover may be a cover having a pivot axis in a lower portion of the housing and opening and closing a side surface of the housing at a front side, the first light emitting portion may expose the first light emitting surface to the side surface of the housing at the front side in the open state of the opening/closing cover, and the second light emitting portion may be arranged so as to expose the second light emitting surface to an area from the side surface of the housing at the front side to an upper surface of the housing in the closed state of the opening/closing cover, in the second aspect.

With this aspect, the opening/closing cover is the cover having the pivot axis in the lower portion of the housing and opening and closing the side surface of the housing at the front side, and the first light emitting portion exposes the first light emitting surface to the side surface of the housing at the front side in the open state of the opening/closing cover. Therefore, the first light emitting portion can be visually recognized from the apparatus front side when the opening/closing cover is opened.

Further, the second light emitting portion is arranged so as to expose the second light emitting surface to an area from the side surface of the housing at the front side to the upper surface thereof in the closed state of the opening/closing cover. Therefore, the light emitted from the second light emitting surface can be visually recognized easily from both of the upper surface side of the housing and the apparatus front side when the opening/closing cover is closed. In this case, the first light emitting portion is covered by the opening/closing cover and is made into a state in which it cannot be visually recognized. Therefore, the light can be preferably guided to the second light emitting surface while suppressing leakage, to the outside, of the light emitted from the first light emitting surface and attenuation of the light.

In a fifth aspect of the present disclosure, a space may be provided between the first light emitting surface and a light receiving surface on which the second light guiding portion receives the light from the first light emitting surface, in any one of the first aspect to the fourth aspect.

With this aspect, the space is provided between the first light emitting surface and the light receiving surface on which the second light guiding portion receives the light from the first light emitting surface. Therefore, the degree of freedom of the layout of the display unit can be further enhanced.

In a sixth aspect of the present disclosure, the light receiving surface may be arranged so as to be inclined with respect to the first light emitting surface, in the fifth aspect.

With this aspect, the same action effects as those obtained by the third aspect can be obtained in the display unit having the configuration in which the light receiving surface is arranged so as to be inclined with respect to the first light emitting surface.

In a seventh aspect of the present disclosure, the first light emitting surface and the light receiving surface on which the second light guiding portion receives the light from the first light emitting surface may make contact with each other, in any one of the first aspect to the fourth aspect.

With this aspect, the first light emitting surface and the light receiving surface on which the second light guiding portion receives the light from the first light emitting surface make contact with each other. Therefore, the light can be effectively guided to the second light emitting portion from the first light emitting portion that emits the light. The first light emitting portion and the second light emitting portion can be arranged in a reduced space.

In an eighth aspect of the present disclosure, the first light emitting portion may be formed with a light-transmitting material containing no light diffusing material, and the second light emitting portion may be formed with a light-transmitting material containing the light diffusing material, in any one of the first aspect to the seventh aspect.

With this aspect, the first light emitting portion is formed with the light-transmitting material containing no light diffusing material. Therefore, when the light emitted from the light source passes through the first light emitting portion, diffusion and attenuation of the light can be suppressed. The light from the light source can therefore be preferably guided to the second light emitting portion.

Furthermore, the second light emitting portion is formed with the light-transmitting material containing the light diffusing material. Therefore, the light passing through the second light guiding portion is diffused to enable the second light emitting surface to emit light preferably.

A medium processing apparatus according to a ninth aspect of the present disclosure includes a processor performing predetermined processing on a medium, a housing including the processor, a displacement member displaceable relative to the housing and configured to be switchable between a first state and a second state of being separated from the housing rather than the first state, and a display unit displaying a state of the apparatus by light, wherein the display unit includes, in the housing, a light source, and a first light emitting portion having a first light emitting surface which emits light toward outside of the housing with light emitted from the light source and a first light guiding portion which guides the light emitted from the light source to the first light emitting surface, and the display unit further includes, in the displacement member, a second light emitting portion having a second light emitting surface which emits light toward the outside of the housing with the light emitted from the first light emitting surface and a second light guiding portion which guides the light emitted from the first light emitting surface to the second light emitting surface when the displacement member is in the first state.

With this aspect, the same action effects as those obtained by the first aspect can be obtained in the medium processing apparatus performing the predetermined processing on the medium.

### BRIEF DESCRIPTION OF THE DRAWINGS

FIG. 1 is an external perspective view of a printer according the present disclosure.

FIG. 2 is a side cross-sectional view illustrating a medium transportation path of the printer.

FIG. 3 is a perspective view illustrating a state in which an opening/closing cover on a side surface of the printer at the front surface side is opened.

FIG. 4 is an enlarged perspective view of a main part of the printer when the opening/closing cover is made into a closed state.

FIG. 5 is an enlarged perspective view of the main part of the printer when the opening/closing cover is made into an open state.

FIG. 6 is a side cross-sectional view illustrating an example of a display unit.

FIG. 7 is a perspective view for explaining a mounting configuration of a second light emitting portion on the opening/closing cover.

FIG. 8 is a side cross-sectional view illustrating a variation of the display unit.

FIG. 9 is a side cross-sectional view illustrating another variation of the display unit.

FIG. 10 is a side cross-sectional view illustrating a swinging member in a first swing state when a first cover on the side surface of the printer at the front side is opened.

FIG. 11 is a side cross-sectional view illustrating the swinging member in a second swing state when the first cover on the side surface of the printer at the front side is opened.

### DESCRIPTION OF EXEMPLARY EMBODIMENTS

### First Embodiment

First, outline of a recording apparatus according to an embodiment of the present disclosure will be described with reference to the drawings. As the recording apparatus, an ink jet printer 1 (hereinafter, referred to as a printer 1 simply in some cases) that discharges ink as liquid onto a medium for recording is used as an example. The printer 1 is also an example of a medium processing apparatus performing predetermined processing on the medium.

In an X-Y-Z coordinate system illustrated in each drawing, an X-axis direction is a width direction of the medium and is an apparatus width direction. A Y-axis direction is a medium transportation direction on a medium transportation path in the recording apparatus and is an apparatus depth direction. A Z-axis direction is an apparatus height direction. The direction to which the medium is transported is referred to as downstream and an opposite direction thereto is referred to as upstream.

### Outline of Printer

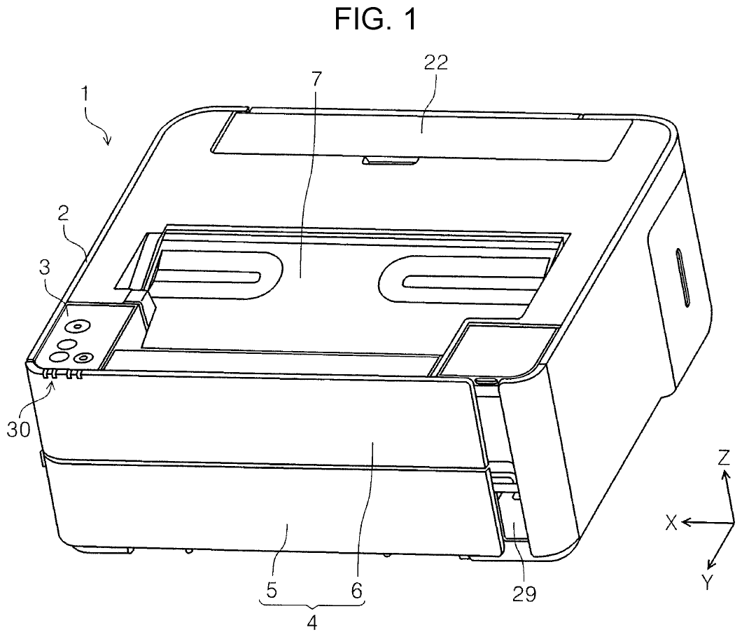

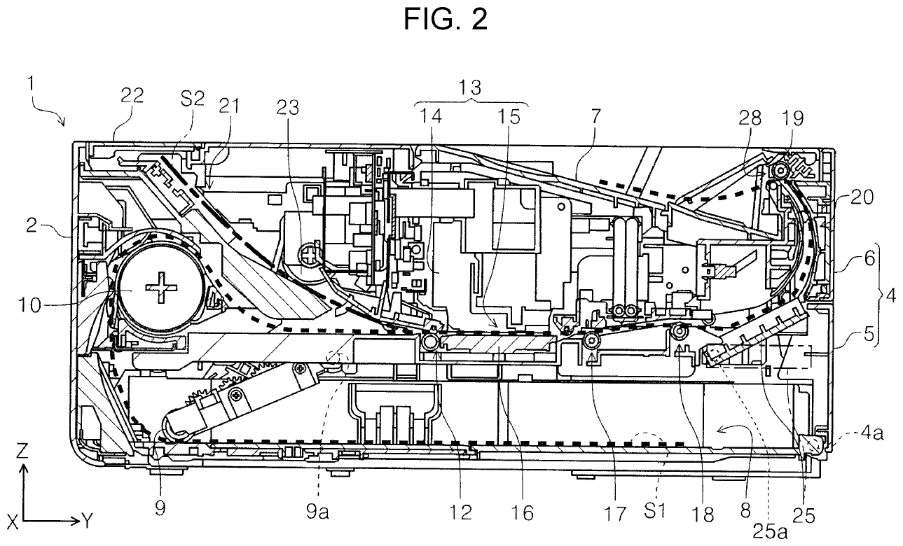

The overall configuration of the printer 1 will be described with reference to FIG. 1 and FIG. 2. An appearance of the printer 1 is configured by a housing 2 as an apparatus exterior. The housing 2 includes therein a recording unit 13 illustrated in FIG. 2.

An operation portion 3 for operating the printer 1 is provided on an upper portion of the housing 2. The operation portion 3 includes a plurality of operation buttons.

A first paper discharge tray 7 is provided on an upper portion of the housing 2. In the embodiment, the first paper discharge tray 7 is configured to receive a medium after recording, which has been discharged from the housing 2, in an inclined posture.

A reference numeral 22 is a feeding portion cover 22 that opens and closes a rear-side feeding portion 21 illustrated in FIG. 2 on an upper portion of the housing 2.

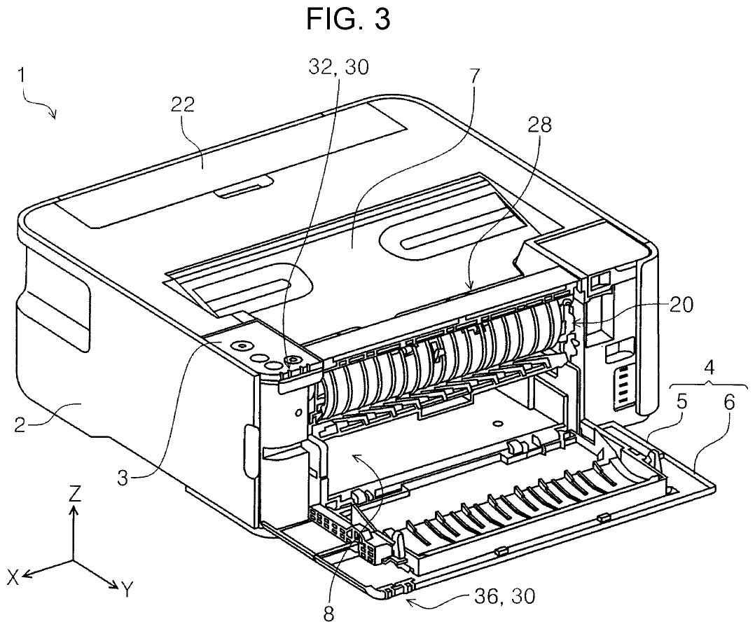

An opening/closing cover 4 is provided on the side surface of the housing 2 at the +Y direction side, that is, the front surface of the housing 2. The opening/closing cover 4 can switch between, by pivoting, a closed state (FIG. 1) of making contact with the housing 2 to make an apparatus inner portion be inaccessible and an open state (FIG. 3) of being separated from the housing 2 to make the apparatus inner portion accessible. The closed state of the opening/closing cover 4 is not limited to a completely open state as illustrated in FIG. 3 and indicates a state in which the opening/closing cover 4 is separated from the housing 2 rather than the closed state in FIG. 1.

In the embodiment, when the closed state of the opening/closing cover 4 is a first state and the open state thereof is a second state, the opening/closing cover 4 is an example of a displacement member that is displaceable relative to the housing 2 and can switch between the first state (FIG. 1) and the second state (FIG. 3) of being separated from the housing 2 rather than the first state.

“Displacement” in the present specification is used to indicate the case in which the overall displacement member is moved and a position thereof is changed, like a cover (displacement member) detachable from the housing 2, and the case in which a part of the displacement member is not moved relative to the housing 2 but an orientation and a posture thereof relative to the housing 2 are changed, like the opening/closing cover 4 mounted so as to pivot relative to the housing 2 as in the embodiment.

A display unit 30 that displays a state of the printer 1 by light is provided on an upper portion of the opening/closing cover 4 in the closed state illustrated in FIG. 1.

Hereinafter, the configurations of the opening/closing cover 4 and the display unit 30 will be described. The medium transportation path in the printer 1 will be described after description of the opening/closing cover 4 and the display unit 30.

### Opening/Closing Cover

The opening/closing cover 4 is a cover which has a pivot axis 4a in a lower portion of the housing 2 and opens and closes the side surface of the housing 2 at the front side (+Y side).

The opening/closing cover 4 includes a first cover 5 and a second cover 6 and is configured that the first cover 5 and the second cover 6 can integrally open as illustrated in FIG. 3.

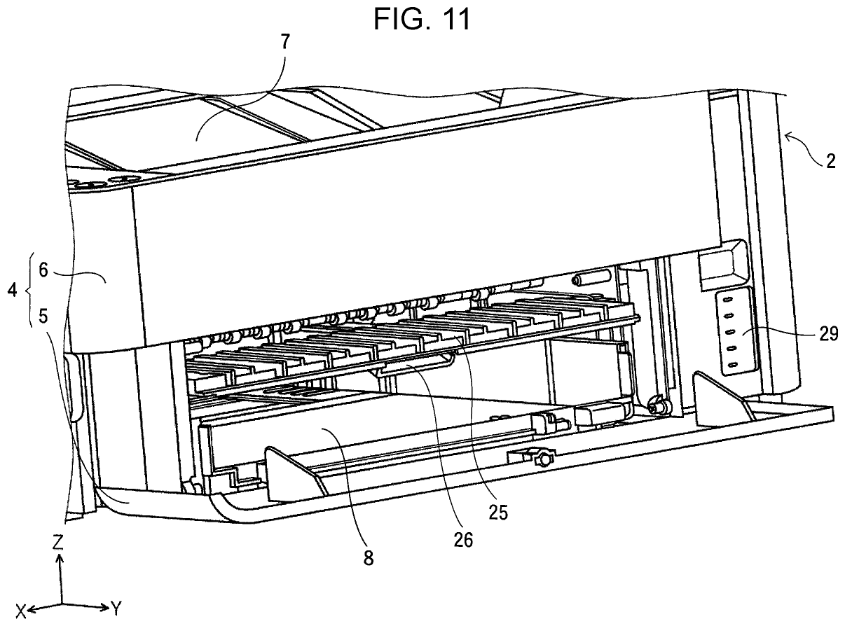

The first cover 5 can be opened alone as illustrated in FIG. 10 and FIG. 11.

When the opening/closing cover 4 is opened as illustrated in FIG. 3, a curved path 20 as a part of the medium transportation path, which will be described later, is exposed. With this process, maintenance such as removal of a paper jam that has occurred on the medium transportation path can be performed.

### Display Unit

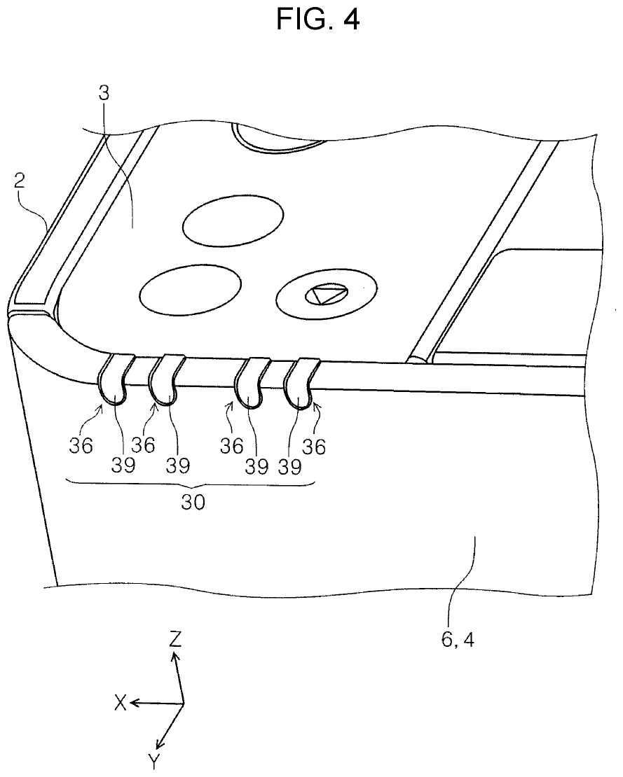

The display unit 30 illustrated in FIG. 4 displays the state of the printer 1 by light, as described above. A plurality of display units 30 can be provided. In the embodiment, four display units 30 are provided with intervals in the apparatus width direction.

Examples of the state of the printer 1 that is displayed on the display units 30 include a standby state, a sleep state, a connected state with another apparatus, various error states, and the like. One display unit 30 can express a plurality of states by lighting the display unit 30 all the time, flashing it, or changing the color of the light thereof.

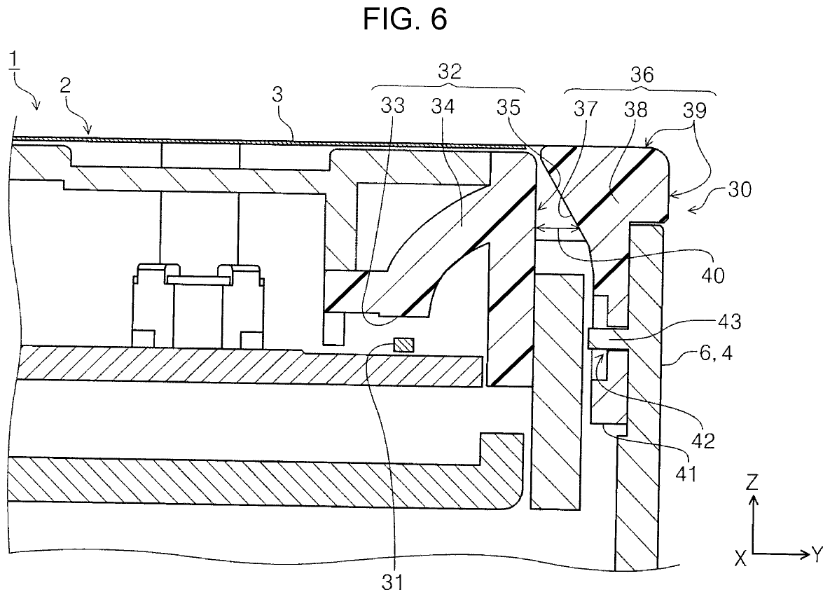

As illustrated in FIG. 6, each display unit 30 in the embodiment includes a light source 31 provided in the housing 2, a first light emitting portion 32 provided in the housing 2, and a second light emitting portion 36 provided in the opening/closing cover 4 (displacement member) side.

To be more specific, each display unit 30 includes, in the housing 2, the light source 31, a first light emitting surface 35 which emits light toward the outside of the housing 2 with light emitted from the light source 31, and a first light guiding portion 34 which guides the light emitted from the light source 31 to the first light emitting surface 35. Further, the display unit 30 includes, in the opening/closing cover 4 (displacement member), a second light emitting surface 39 which emits light toward the outside of the housing 2 with the light emitted from the first light emitting surface 35 and a second light guiding portion 38 which guides the light emitted from the first light emitting surface 35 to the second light emitting surface 39 when the opening/closing cover 4 (displacement member) is in the closed state (first state). The second light emitting portion 36 includes the second light guiding portion 38 having a second light receiving surface 37 as a light receiving surface which receives the light from the first light emitting surface 35.

With this configuration of the display units 30, when the opening/closing cover 4 is in the closed state (first state), light emitted from the light sources 31 enters the first light guiding portions 34 from first light receiving surfaces 33 and is guided by the first light guiding portions 34 to cause the first light emitting surface 35 (first light emitting portions 32) to emit light, and the light emitted from the first light emitting surfaces 35 enters the second light guiding portions 38 from the second light receiving surfaces 37 and is guided by the second light guiding portions 38 to cause the second light emitting surfaces 39 (second light emitting portions 36) to emit light. Accordingly, in the closed state of the opening/closing cover 4, the display units 30 display the state of the printer 1 by the light emission of the second light emitting surfaces 39 of the second light emitting portions 36.

On the other hand, when the opening/closing cover 4 is opened to be made into the open state (second state), the second light receiving surfaces 37 of the second light emitting portions 36 are separated from the first light emitting surface 35 of the first light emitting portions 32 rather than the closed state. When the second light receiving surfaces 37 are separated from the first light emitting surface 35, the light emitted from the first light receiving surfaces 33 is diffused to the outside and the light emitted from the first light receiving surfaces 33 hardly enters the second light guiding portions 38. When the second light receiving surfaces 37 are separated from the first light emitting surface 35 by equal to or more than a predetermined distance, the light having intensity with which the second light emitting surfaces 39 can emit light does not enter the second light guiding portions 38. Accordingly, when the opening/closing cover 4 is opened, light emission of the second light emitting surfaces 39 is suppressed. When the opening/closing cover 4 is opened by equal to or more than a predetermined distance, the second light emitting surfaces 39 emit no light.

However, even when the second light emitting surfaces 39 of the second light emitting portions 36 emit no light, the first light emitting surfaces 35 of the first light emitting portions 32 provided in the housing 2 emit light. Therefore, the display units 30 can display the state of the printer 1 by the light emission of the first light emitting surfaces 35 of the first light emitting portions 32.

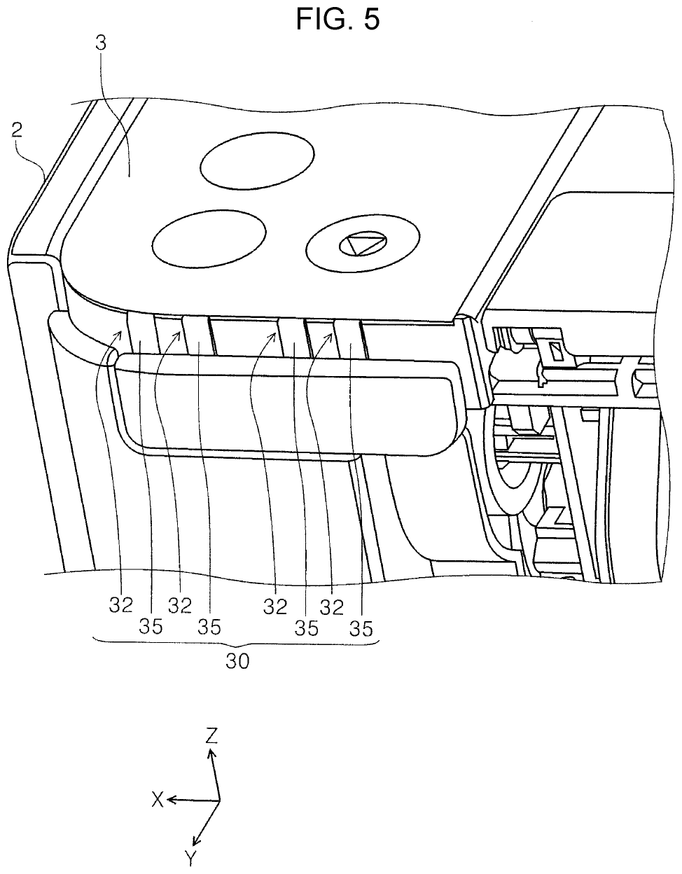

In the embodiment, in both of the case in which the second light emitting portions 36 are visually recognized while the opening/closing cover 4 is made into the closed state as illustrated in FIG. 1 and FIG. 4 and the case in which the first light emitting portions 32 are visually recognized while the opening/closing cover 4 is made into the open state as illustrated in FIG. 3 and FIG. 5, a visually recognizing position of the display units 30 relative to the housing 2 is almost the same.

That is to say, the light of the display units 30 can be visually recognized at a predetermined position in both of the closed state and the open state of the opening/closing cover 4.

Further, one light sources 31 enable both of the first light emitting portions 32 and the second light emitting portions 36 to emit light. Therefore, the display units 30 can be arranged in a reduced space and the degree of freedom of the layout of the display units 30 can be enhanced.

The first light emitting surfaces 35 are arranged so as not to be visually recognized when the opening/closing cover 4 (displacement member) is made into the closed state (first state).

In the embodiment, the first light emitting surfaces 35 of the first light emitting portions 32 are exposed to the side surface of the housing 2 at the front side (+Y side) in the open state of the opening/closing cover 4 as illustrated in FIG. 5. The first light emitting surfaces 35 of the first light emitting portions 32 are covered and hidden by the opening/closing cover 4 in the closed state of the opening/closing cover 4 as illustrated in FIG. 4 and appear in the open state of the opening/closing cover 4.

With the above-described arrangement of the first light emitting surfaces 35, the light can be preferably guided to the second light emitting surfaces 39 while suppressing leakage, to the outside, of the light emitted from the first light emitting surfaces 35 and attenuation of the light when the opening/closing cover 4 is made into the closed state.

When a maintenance operation such as removal of a paper jam in the medium transportation path is performed by opening the opening/closing cover 4, the printer 1 is viewed such that the side surface at the apparatus front side on which the medium transportation path is exposed is viewed from the front side. Accordingly, exposure of the first light emitting surfaces 35 to the side surface of the housing 2 at the front side (+Y side) in the open state of the opening/closing cover 4 makes the first light emitting portions 32 be visually recognized easily from the apparatus front side during the operation which is performed in the open state of the opening/closing cover 4.

As illustrated in FIG. 4, the second light emitting portions 36 are arranged such that the second light emitting surfaces 39 are exposed to an area from the side surface of the housing 2 at the front side (+Y side) to the upper surface side (+Z side) in the closed state of the opening/closing cover 4.

With this arrangement, when the opening/closing cover 4 is closed, the light emitted from the second light emitting surfaces 39 can be visually recognized easily from both of the upper surface side and the apparatus front side of the housing 2.

In the embodiment, spaces 40 are provided between the first light emitting surfaces 35 and the second light receiving surfaces 37, as illustrated in FIG. 6. The degree of freedom of the layout of the display units 30 can be further enhanced by providing the spaces 40 between the first light emitting surfaces 35 and the second light receiving surfaces 37.

The second light receiving surfaces 37 are arranged so as to be inclined with respect to the first light emitting surfaces 35. The second light receiving surfaces 37 are arranged so as to be inclined with respect to the first light emitting surfaces 35, thereby increasing the areas of the second light receiving surfaces 37.

The second light receiving surfaces 37 in the embodiment are inclined in the direction of being farther from the first light emitting surfaces 35 from the upper portions to the lower portions of the second light receiving surfaces 37, as illustrated in FIG. 6. The inclination directions of the second light receiving surfaces 37 are not limited thereto. Alternatively, the second light receiving surfaces 37 can also be inclined in the direction of making close to the first light emitting surfaces 35 to the lower portions from the upper portions of the second light receiving surfaces 37.

A light emitting diode (LED) light as an example can be used for the light sources 31 of the display units 30. The first light emitting portions 32 and the second light emitting portions 36 are formed with a light-transmitting material which transmits light. As an example, a resin material having a light-transmitting property can be used.

As the light-transmitting resin material, as an example, an acrylic, a styrene, a polyethylene, a polycarbonate, or the like of a resin material can be used. Alternatively, glass can also be used.

In the embodiment, the first light emitting portions 32 are formed with a light-transmitting material containing no light diffusing material and the second light emitting portions 36 are formed with a light-transmitting material containing the light diffusing material.

The first light emitting portions 32 are formed with the light-transmitting material containing no light diffusing material. Therefore, when the light emitted from the light sources 31 passes through the first light guiding portions 34 of the first light emitting portions 32, diffusion and attenuation of the light can be suppressed, so that the light from the light sources 31 can be preferably guided to the second light emitting portions 36.

Further, the second light emitting portions 36 are formed with the light-transmitting material containing the light diffusing material. Therefore, the light passing through the second light guiding portions 38 is diffused to enable the second light emitting surfaces 39 to emit light preferably.

The first light emitting portions 32 can also be formed with the light-transmitting material containing the light diffusing material. In this case, the content of the light diffusing material contained in the light-transmitting material forming the first light emitting portions 32 is desired to be relatively lower than the content of the light diffusing material contained in the light-transmitting material forming the second light emitting portions 36.

It is sufficient that the light diffusing material is a material having a light diffusing function when added to the light-transmitting material, and for example, inorganic particles of aluminum oxide, silicon oxide, titanium oxide, calcium carbonate, or the like can be used. Further, organic particles of silicone resin, acrylic resin, or the like can be used. The light diffusing material may be glass powder. A single type of the light diffusing material may be used alone or equal to or more than two types thereof may be used in combination.

In the embodiment, the printer 1 (recording apparatus) as an example of the medium processing apparatus has been described. However, the display unit in the present disclosure can also be applied to, for example, a scanner (image reading apparatus) as the medium processing apparatus that performs reading processing of reading an image on a medium by a reading unit as a processor performing predetermined processing on the medium.

### Mounting of Second Light Emitting Portion on Opening/Closing Cover

Next, a mounting configuration of the second light emitting portions 36 on the opening/closing cover 4 will be described.

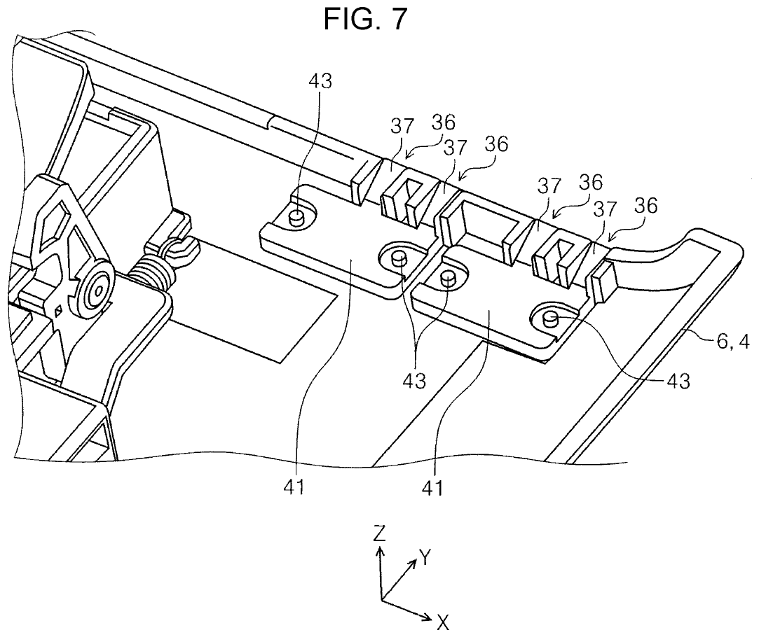

As illustrated in FIG. 7, the second light emitting portions 36 are integrally molded on mounting plates 41 having mounting holes 42 (FIG. 6) which are fitted with projections 43 (see also FIG. 6) provided on the second cover 6 (opening/closing cover 4).

Although in the embodiment, the two adjacent second light emitting portions 36 are integrally molded on one mounting plate 41, all of the second light emitting portions 36 may be integrally molded on one mounting plate 41. Alternatively, each second light emitting portion 36 can be mounted on the individual mounting plate 41.

### Variations of Display Unit

### First Variation

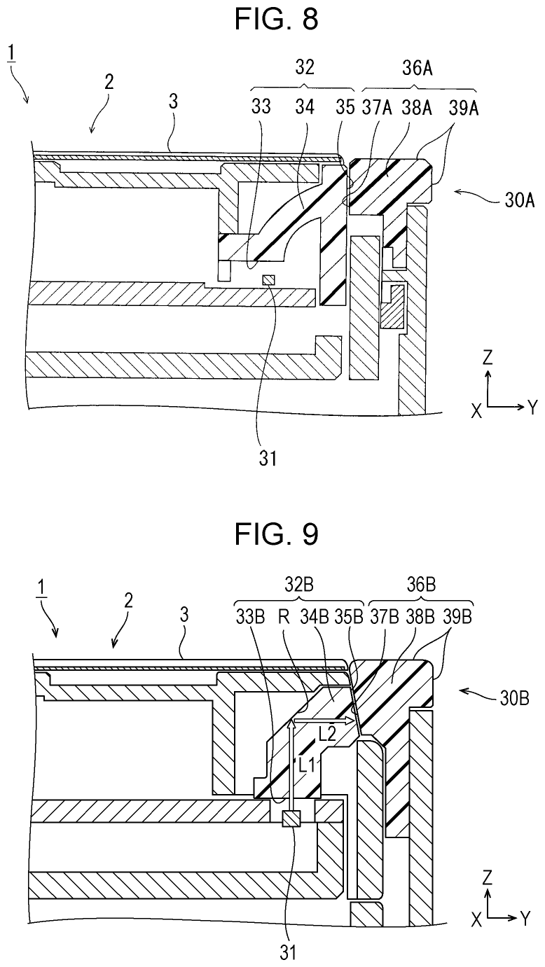

A display unit 30A illustrated in FIG. 8 can be employed instead of the display unit 30 illustrated in FIG. 6.

In a second light emitting portion 36A of the display unit 30A illustrated in FIG. 8, a second light receiving surface 37A on which a second light guiding portion 38A receives light from the first light emitting surface 35 is formed so as to make contact with the first light emitting surface 35. That is to say, the first light emitting surface 35 and the second light receiving surface 37A make surface contact with each other.

The first light emitting portion 32 of the display unit 30A is configured in the same manner as the display unit 30 illustrated in FIG. 6, and the second light receiving surface 37A of the display unit 30A is formed as a surface along the vertical direction (Z-axis direction) so as to correspond to the first light emitting surface 35.

In FIG. 8, the first light emitting surface 35 and the second light receiving surface 37A are illustrated so as to be slightly spaced from each other in order to illustrate the first light emitting surface 35 and the second light receiving surface 37A to be understood easily.

With this configuration, the light can be effectively guided to the second light guiding portion 38A from the first light emitting surface 35 emitting light, so that a second light emitting surface 39A can be made to preferably emit light. Further, the space 40 as illustrated in FIG. 6 is not provided, so that the first light emitting portion 32 and the second light emitting portion 36A can be arranged in a reduced space.

It should be noted that in the display unit 30A, the light source 31 and the first light emitting portion 32 are configured in the same manner as the display unit 30.

### Second Variation

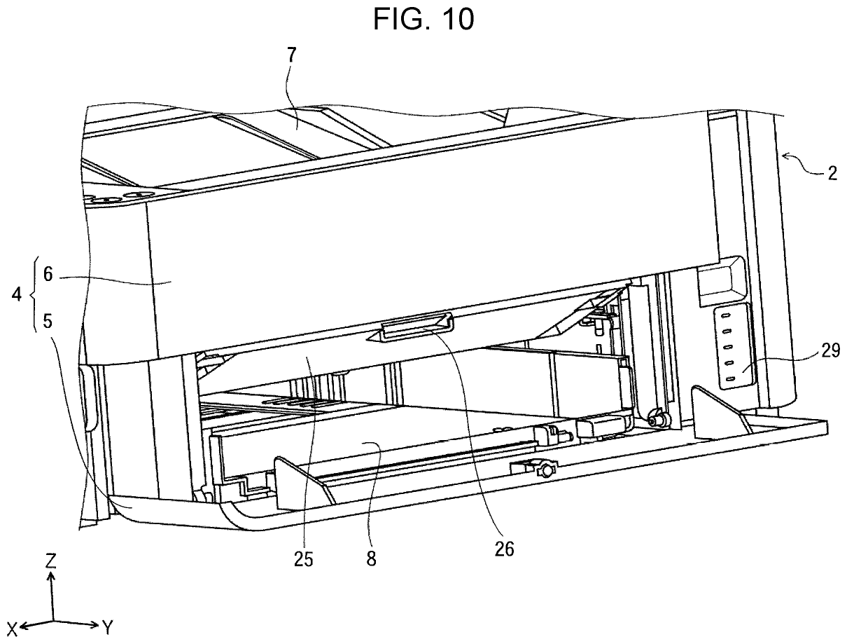

Further, the display unit can be replaced by a display unit 30B as illustrated in FIG. 9.

Also in the display unit 30B illustrated in FIG. 9, a first light emitting surface 35B of a first light emitting portion 32B and a second light receiving surface 37B of a second light emitting portion 36B are formed so as to make contact with each other.

The second light receiving surface 37B is inclined in such a direction that a lower portion thereof is located at the +Y side relative to an upper portion thereof. The first light emitting surface 35B is inclined in such direction that a lower portion of the first light emitting surface 35B is located at the +Y side relative to an upper portion thereof, similarly to the second light receiving surface 37B.

Contact between the first light emitting surface 35B and the second light receiving surface 37B enables light to be effectively guided to a second light guiding portion 38B from the first light emitting surface 35B which emits light, so that a second light emitting surface 39B can be made to preferably emit light.

Also in FIG. 9, the first light emitting surface 35B and the second light receiving surface 37B are illustrated so as to be slightly spaced from each other in order to illustrate the first light emitting surface 35B and the second light receiving surface 37B to be understood easily.

In the first light emitting portion 32B, a reflection surface R is provided on a first light guiding portion 34B. The reflection surface R is configured so as to reflect light L1 from the light source 31, which has been incident thereon from a first light receiving surface 33B, and guide reflected light L2 to the first light emitting surface 35B.

The light emitted from the light source 31 can be preferably guided to the first light emitting surface 35B by providing the reflection surface R on the first light guiding portion 34B.

### Medium Transportation Path of Printer

Medium Transportation Path from Medium Storage Portion to First Paper Discharge Tray

A medium transportation path S1 (indicated by a bold dashed line in FIG. 2) from a medium storage portion 8 provided in a lower portion of the housing 2 to the first paper discharge tray 7 will be described mainly with reference to FIG. 2.

The medium storage portion 8 is provided in an end portion of the housing 2 at the −Z direction side in FIG. 2. The medium storage portion 8 can store therein a plurality of media. As the medium, paper such as plain paper, thin paper, thick paper, coated paper, and photograph paper, or the like can be exemplified.

A pickup roller 9 is provided at the +Z direction side of the medium storage portion 8. The pickup roller 9 can pivot about a pivot axis 9a as a fulcrum. The pickup roller 9 makes contact with the media stored in the medium storage portion 8 to transport an uppermost medium of the media stored in the medium storage portion 8 to the downstream in the medium transportation direction.

An inversion roller 10 is provided at the downstream of the pickup roller 9. A plurality of driven rollers (not illustrated) which rotates while following the inversion roller 10 is arranged around the inversion roller 10.

The medium fed by the pickup roller 9 is inverted by the inversion roller 10 and is fed to a feeding roller pair 12 provided at the downstream in the medium transportation direction. The recording unit 13 performing recording on the medium is provided at the downstream of the feeding roller pair 12 in the medium transportation direction.

In the printer 1, the recording unit 13 is a “processor” performing processing on the medium and performs recording processing by ejecting ink onto the medium. The recording unit 13 is provided on a carriage 14. The carriage 14 is configured to be movable in the X-axis direction and a recording head 15 that discharges the ink in the −Z direction is provided on a lower portion of the carriage 14.

The ink (liquid) that is supplied to the recording unit 13 is supplied from an ink tank 29 (FIG. 1) provided at the +X-axis direction side in the housing 2 with a supply tube (not illustrated) interposed therebetween.

A medium support portion 16 is provided below the recording head 15 in a region facing the recording head 15. The medium support portion 16 supports the lower surface (surface at the opposite side to a recording surface) of the medium transported to the region facing the recording head 15 by the feeding roller pair 12.

The recording head 15 discharges the ink onto the medium supported by the medium support portion 16 to execute recording on the recording surface of the medium.

A first roller pair 17 and a second roller pair 18 as discharge roller pairs that feed the medium after recording are provided at the downstream of the recording head 15 in the medium transportation direction.

The curved path 20 inverting the medium is provided at the downstream of the second roller pair 18 in the medium transportation direction. The medium after recording is fed to the first roller pair 17 and the second roller pair 18 and is inverted on the curved path 20.

A third roller pair 19 is provided at an exit of the curved path 20, and the medium inverted on the curved path 20 is discharged from a discharging portion 28 and is placed on the first paper discharge tray 7.

Each of the feeding roller pair 12, the first roller pair 17, the second roller pair 18, and the third roller pair 19 is configured by a driving roller (with no reference numeral) that is driven by a driving source (not illustrated) and a driven roller (with no reference numeral).

The above description has been made for the medium transportation path S1 from the medium storage portion 8 to the first paper discharge tray 7. Subsequently, transportation of the medium from the rear-side feeding portion 21 will be described.

Medium Transportation Path from Rear-Side Feeding Portion to First Paper Discharge Tray

A medium transportation path S2 (indicated by a bold alternate long and short dash line in FIG. 2) from the rear-side feeding portion 21 will be described with reference to FIG. 2.

The rear-side feeding portion 21 is provided at the rear side (−Y side) in the housing 2. The feeding portion cover 22 (see FIG. 1) that covers the rear-side feeding portion 21 is provided on an upper portion of the housing 2, as described above. The feeding portion cover 22 can pivot relative to the housing 2 and can switch between a closed state (FIG. 2) and an open state (not illustrated). The medium can be fed to the recording unit 13 in the housing 2 from the rear-side feeding portion 21 by making the feeding portion cover 22 into the open state.

A feeding roller 23 is provided at the downstream of the feeding portion cover 22. The medium set on the rear-side feeding portion 21 is fed by the feeding roller 23. The medium transportation path S2 joins, at the upstream of the feeding roller pair 12, to the medium transportation path S1 (dashed line) from the medium storage portion 8 described above. Thereafter, the medium is fed to the recording unit 13, is subject to recording, passes through the curved path 20, and is discharged onto the first paper discharge tray 7, in the same manner as on the medium transportation path S1.

Discharge onto Second Paper Discharge Tray

The printer 1 can discharge the medium after recording by the recording unit 13 onto the first paper discharge tray 7 and can discharge it onto, as a second paper discharge tray, a swinging member 25 provided at the upstream of the curved path 20 in FIG. 2.

The swinging member 25 illustrated in FIG. 2 includes a swing shaft 25a and can switch between a first swing state (state of the swinging member 25 indicated by a solid line in FIG. 2) in which it configures a part of a path surface of the medium transportation path S1 to guide the medium after recording to the curved path 20 and a second swing state (state of the swinging member 25 indicated by an alternate long and short dash line in FIG. 2) in which it serves as the second paper discharge tray as a discharge destination of the medium after recording.

When the discharge destination of the medium after recording is switched from the first paper discharge tray 7 to the swinging member 25 as the second paper discharge tray, the first cover 5 is opened and the posture of the swinging member 25 is switched to the second swing state from the first swing state.

FIG. 10 is a view when the first cover 5 is opened and the swinging member 25 in the first state is seen from the apparatus outer side. As illustrated in FIG. 10, a handle portion 26 is provided on the swinging member 25 at the free end side (+Y side) and a user can swing the swinging member 25 by handling the handle portion 26.

As illustrated in FIG. 11, when the first cover 5 is opened and the swinging member 25 is made into the second swing state, the medium after recording by the recording unit 13 is fed by the first roller pair 17 and the second roller pair 18, and is discharged from the apparatus front surface side (+Y side) of the housing 2 while being supported by the swinging member 25 in the second swing state.

As illustrated in FIG. 10 and FIG. 11, when the first cover 5 is made into the open state, a part of the medium storage portion 8 is exposed. In the state in which the first cover 5 is opened, a part of the medium storage portion 8 can be drawn to the apparatus front surface side of the housing 2 and the medium can be easily supplied to the medium storage portion 8.

The present disclosure is not limited to the above embodiment and various variations can be made within a range of the disclosure, which is described in the scope of the disclosure. It is needless to say that the variations are also encompassed in the scope of the disclosure.

What is claimed is:

1. A recording apparatus comprising:
a housing;
a recording unit arranged inside the housing and performing recording on a medium;
an opening/closing cover configured to open and close an opening in a front of the housing; and
a display unit displaying a state of the apparatus using light, wherein
the opening/closing cover is switchable between a first open state, a second open state and a closed state,
the first open state is a state in which the opening is opened,
the second open state is a state in which a part of the opening is opened while a part of the opening is closed,
the closed state is a state in which the opening is closed,
the display unit includes a light source in the housing, a first light emitting portion in the housing, and a second light emitting portion in a displacement member,
the first light emitting portion is arranged to be visible when the opening/closing is in the first open state, and
the second light emitting portion is arranged to be visible when the opening/closing is in the second open state or the closed state.

2. The recording apparatus according to claim 1, further comprising:
a medium transportation path in which the medium is transported, wherein
the medium transportation path includes a curved path on which the medium is inverted, and
the curved path is exposed when the opening/closing cover is in the first open state.

3. The recording apparatus according to claim 2, further comprising:
a medium storage portion configured to store therein a plurality of media, wherein
the medium is exposed when the opening/closing cover is the first second state.

4. The recording apparatus according to claim 3, wherein
the medium on which the recording is performed is configured to be discharged from the front of the housing when the opening/closing cover is in the second open state.

5. The recording apparatus according to claim 4, wherein
the medium transportation path includes a swinging member,
the swinging member is configured to switch between a first swing state and a second swing state,
the first swing state is a state in which the swinging member guides the medium on which the recording is performed to the curved path, and
the second swing state is a state in which the swinging member guides the medium on which the recording is the performed to be discharged from the front of the housing.

6. The recording apparatus according to claim 1, wherein
the opening/closing cover includes a first cover and a second cover,
the first cover and the second cover are configured to integrally open,
the opening/closing cover is in the first open state by integrally opening the first cover and the second cover and is in the second open state by opening only the first cover.

7. The recording apparatus according to claim 6, wherein
the first cover is below the second cover.

8. The recording apparatus according to claim 7, wherein
the first cover includes the second light emitting portion, and
the second cover includes a pivot axis.

9. The recording apparatus according to claim 1, wherein
the first light emitting portion is arranged at the front of the housing,
the second light emitting portion is arranged from the front of the recording apparatus to a top side of the recording apparatus and at a corner edge of the recording apparatus, and
the first light emitting portion overlaps a part of the second light emitting portion when viewed from the front of the housing.

10. The recording apparatus according to claim 1, wherein
the first light emitting portion has:
a first light receiving surface that receives light,
a first light emitting surface that emits light,
a first light guiding portion that guides the light and that is arranged between the first light receiving surface and the first light emitting surface,
the second light emitting portion has:
a second light receiving surface that receives light,
a second light emitting surface that emits light, and
a second light guiding portion that guides the light and that is arranged between the second light receiving surface and the second light emitting surface,
the first light receiving surface receives light emitted from the light source,
the second light receiving surface receives light emitted from the first light emitting surface, and
the second light receiving surface is arranged to be inclined with respect to the first light emitting surface.

11. The recording apparatus according to claim 10, wherein
the first light emitting surface and the second light receiving surface make contact with each other.

12. The recording apparatus according to claim 11, wherein
the first light emitting portion having a first light diffusion performance, and
the second light emitting portion having a second light diffusion performance that is greater than the first light diffusion performance.
